(19) United States
(12) Patent Application Publication
(10) Pub. No.: US 2013/0283043 A1
(43) Pub. Date: Oct. 24, 2013

(54) METHOD AND APPARATUS FOR AUTHORIZATION UPDATING

(71) Applicants: PEKING UNIVERSITY FOUNDER GROUP CO., LTD., Beijing (CN); BEIJING FOUNDER APABI TECHNOLOGY LTD., Beijing (CN)

(72) Inventors: Yilei CHEN, Beijing (CN); Wei WAN, Beijing (CN); Chao QU, Beijing (CN)

(73) Assignees: BEIJING FOUNDER APABI TECHNOLOGY LTD., Beijing (CN); PEKING UNIVERSITY FOUNDER GROUP CO., LTD., Beijing (CN)

(21) Appl. No.: 13/869,387

(22) Filed: Apr. 24, 2013

(30) Foreign Application Priority Data
Apr. 24, 2012 (CN) 201210122510.7

(51) Int. Cl. H04L 29/06

(52) U.S. Cl. CPC H04L 63/0823
USPC 713/156; 726/4

(57) ABSTRACT

A method for updating an authorization of electronic information includes receiving, by an authorization updating server, first information from a user equipment requesting for updating authorization items, wherein the first information includes first identification information and a first list of authorization items requested to be updated, determining a second list of authorization items stored in the authorization updating server that correspond to the first identification information, comparing the first list of authorization items and the second list of authorization items and determining a third list including authorization items that are listed in both the first list and the second list of authorization items, and transmitting the third list of authorization items to the user equipment.

### CROSS REFERENCE OF RELATED APPLICATION(S)

This application claims the benefit of Chinese Patent Application No. 201210122510.7, filed on Apr. 24, 2012, which is incorporated by reference in its entirety.

### FIELD OF THE INVENTION

The present invention relates to the field of processing electronic information and particularly to a method and apparatus for updating authorization of using electronic information.

### BACKGROUND OF THE INVENTION

Along with the increasing popularization of electronic information resources in our daily life, various devices can provide reading in support of the electronic information resources. These devices include PCs, U-disks, mobile phones, tablet computers, electronic book readers, professional handheld devices and other different types of devices. To guarantee proper use of the resources in an authorized device, digital certificates and encryption have been used. A digital content authorization corresponding to the authorized resources in the device often needs to be obtained again or updated. A method for updating the digital content authorization thereof can be provided to guarantee the security of the digital certificate and make it convenient for a user to obtain or update the digital certificate.

At present, a majority of storage devices transmit an update request to a digital certificate authentication server through a user equipment, and after the storage devices receive a reissued digital certificate processed by and then returned from an authorization updating server, the invalidated digital certificate is replaced by the reissued digital certificate received by the user. The invalidated certificate can be entirely replaced by the obtained updated certificate.

In the prior art, each time the user equipment requests for an authorization or a renewed authorization, the request of the user has to be verified for legality, a right of the user has to be obtained, the request right has to be checked for legality, the items that the user has right with have to be reallocated and encrypted, and then communication with a client is performed. Considerable server performance may be consumed for authorization with numerous items and detailed control, and this situation may be aggravated and a normal distribution of the authorization may be affected in a high-concurrence scenario.

### SUMMARY OF THE INVENTION

The present disclosure provides a method and apparatus for updating an authorization of using electronic information so as to address the problem of replacing an invalidated certificate with an updated authorization certificate in the certificate authorization process.

According to some embodiments, a method for updating an authorization of electronic information includes receiving, by an authorization updating server, first information from a user equipment requesting for updating authorization items, wherein the first information includes first identification information and a first list of authorization items requested to be updated, determining, by the authorization updating server, a second list of authorization items stored in the authorization updating server that correspond to the first identification information, comparing, by the authorization updating server, the first list of authorization items and the second list of authorization items and determining a third list including authorization items that are listed in both the first list and the second list of authorization items, and transmitting, by the authorization updating server, the third list of authorization items to the user equipment.

According to some other embodiments, a method for updating authorization items includes checking, by a user equipment, each authorization item in a resource certificate for validity, and generating a first list of authorization items to request for updating according to a result of the checking, obtaining first identification information, wherein the first identification information comprises user identification information and certificate identification information, transmitting first information to an authorization updating server, wherein the first information includes the first list of authorization items and the first identification information, receiving a third list of authorization items from the authorization updating server, and updating authorization items in the resource certificate according to the authorization items in the third list.

According to some embodiments, an apparatus for updating authorization of use of electronic information includes an obtaining module configured to obtain first information from a user equipment requesting for updating authorization items, wherein the first information includes a first list of authorization items requested to be updated and first identification information, an authorization item determining module configured to compare the first list of authorization items with a second list that includes authorization items stored in the apparatus and correspond to the first identification information, and determine authorization items that are in the first list and the second list as authorization items to be updated, an authorization item list obtaining module configured to generate a third list of authorization items determined to be updated for the user equipment, and a transmitting module configured to transmit the third list of authorization items determined to be updated for the user equipment to the user equipment.

### BRIEF DESCRIPTION OF THE DRAWINGS

FIG. 1 is a flow chart of a method for updating an authorization according to some embodiments of the present disclosure;

FIG. 2 is a flow chart of a method for updating sub-authorization items according to some embodiments of the present disclosure;

FIG. 3 is a schematic structural diagram of an apparatus for updating an authorization according to some embodiments of the present disclosure;

FIG. 4 is a schematic diagram of a specific structure of a sub-authorization item determining module according to some embodiments of the present disclosure;

FIG. 5 is a schematic diagram of a specific structure of a transmitting module according to some embodiments of the present disclosure;

FIG. 6 is a schematic structural diagram of an apparatus for updating sub-authorization items according to some embodiments of the present disclosure; and

FIG. 7 is a schematic diagram of a specific structure of a request transmitting module according to some embodiments of the present disclosure.

### DETAILED DESCRIPTION OF THE EMBODIMENTS

The present disclosure provides a method and system for updating an authorization of using electronic information. The system may include an authorization updating server that can obtain first information transmitted from a user equipment requesting for updating authorization items, obtain a corresponding list of authorization items according to the first information and perform authorization updating on sub-authorization items to be updated listed in resource certificate information in the user equipment according to the list of authorization items.

The embodiments of the present disclosure will be detailed below in combination with the drawings.

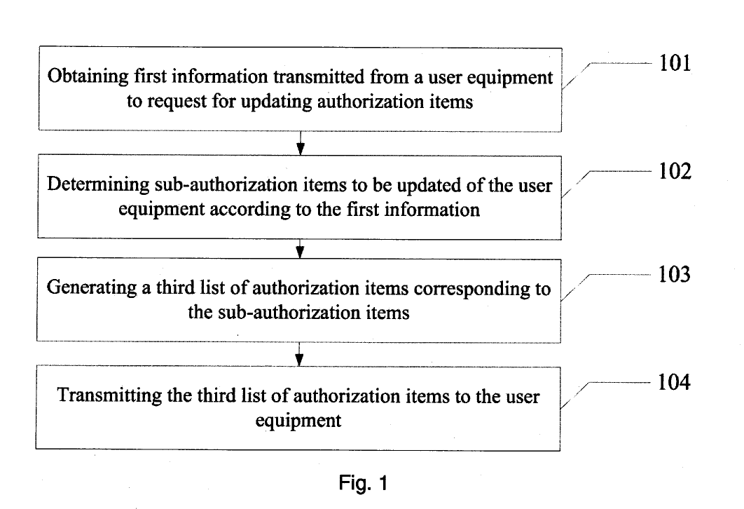

FIG. 1 illustrates a flow chart of a method for updating an authorization of using electronic information according to some embodiments of the present disclosure. The method may include:

Step 101, obtaining first information transmitted from a user equipment requesting for updating authorization items. The authorization items may include electronic information resources. The first information includes first identification information, a list of requested authorization items to be updated, and/or a first hash value of a key.

Step 102, determining sub-authorization items to be updated of the user equipment according to the first information.

An authorization updating server, after receiving first information transmitted from a user equipment requesting for updating authorization items, parses the first information to get the first identification information, the list of requested authorization items, and the first hash value.

Particularly, the first identification information includes first user identification information, first device information of the user equipment, and first certificate information associated with the user.

The first hash value is obtained by the user equipment by a hash operation on the first user identification information, the first device information, and the first certificate information. The hash value may be encrypted with a key pre-stored in the user equipment.

The authorization updating server may then decrypt the first hash value including the key in the first information by a pre-stored key. In some embodiments, the pre-stored key in the authorization updating server is synchronized with the key pre-stored in the user equipment, so that the authorization updating server can obtain the first hash value through the decryption.

The authorization updating server may perform a hash operation on the first identification information in the first information to obtain a second hash value. The hash operation in the authorization updating server and the hash operation in the user equipment may use the same hash algorithm.

After obtaining the first hash value and the second hash value, the authorization updating server matches the first hash value with the second hash value. If the first hash value is not the same as the second hash value, the authorization updating server determines that the matching fails and the authorization updating server rejects the request of updating the list of authorization items; if the first hash value is the same as the second hash value, the authorization updating server determines that the matching succeeds.

The authorization updating server may have pre-stored sub-authorization items. The authorization updating server may determine which pre-stored sub-authorization items correspond to the first user identification information and the first certificate identification information according to the first user identification information and the first certificate identification information after the matching succeeds. The so-called sub-authorization items are a sub set or a smaller group of authorization items that belong to a bigger group of authorization items.

Step 103, generating a third list of authorization items corresponding to the sub-authorization items.

The authorization updating server may generate a list of pre-stored sub-authorization items that correspond to the first user identification information and the first certificate identification information after obtaining the pre-stored sub-authorization items in the step 102.

The obtained list of requested sub-authorization items from the user equipment is compared with the generated list of pre-stored sub-authorization items that correspond to the first user identification information and the first certificate identification information. The authorization updating server determines whether the list of pre-stored sub-authorization items includes the requested sub-authorization items (which are requested by the user equipment to be updated). If a requested sub-authorization item is included in the list, the authorization updating server adds it in a third list.

Thus, the authorization updating server obtains a third list of authorization items including the sub-authorization items, which can be updated for the user equipment.

In order to transmit the third list of authorization items between the authorization updating server and the user equipment securely, the authorization updating server performs a hash operation on the third list of sub-authorization items, obtains a third hash value through the hash operation and encrypts the third hash value by the pre-stored key before transmitting the third list of sub-authorization items.

Step 104, transmitting the third list of sub-authorization items to the user equipment.

The authorization updating server stores the obtained third list of sub-authorization items and transmits second information, including the third list of sub-authorization items and the third hash value, to the user equipment. The user equipment performs authorization updating on the sub-authorization items to be updated in resource certificate information in the user equipment according to the third list of authorization items.

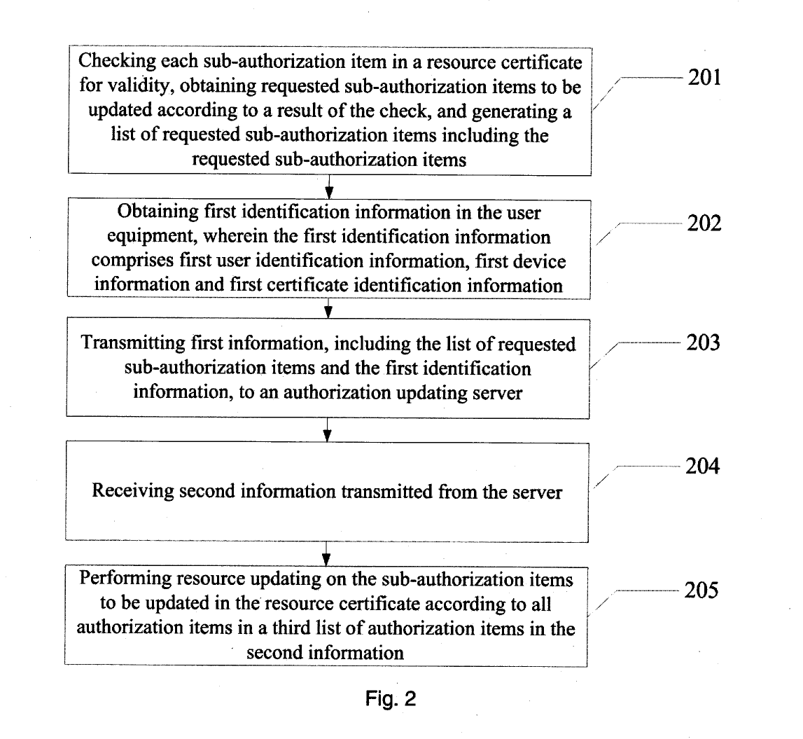

As shown in FIG. 2, the user equipment can perform authorization updating on the sub-authorization items as follows:

Step 201, checking each sub-authorization item in a resource certificate for validity, obtaining sub-authorization items to be requested for updating according to a result of the check, and generating a list of requested sub-authorization items including the requested sub-authorization items.

According to some embodiments, the resource certificate includes a plurality of sub-authorization items. When the resource certificate needs to be updated, the user equipment checks each sub-authorization item in the resource certificate for validity. The invalid sub-authorization items are considered as items to be updated. The user equipment adds the invalid sub-authorization items to a list of sub-authorization items to be requested for updating. This is the list of requested sub-authorization items to be included in the first information.

As discussed above, the requested sub-authorization items can be invalid sub-authorization items in the resource certificate, which can be obtained automatically by the user equipment. Alternatively, a user can select sub-authorization items to be updated and request for an update.

Step 202, obtaining first identification information in the user equipment. The first identification information includes first user identification information, first device information, and first certificate identification information.

Step 203, transmitting first information, including the list of requested sub-authorization items and the first identification information, to an authorization updating server.

Before transmitting the first information to the authorization updating server, the user equipment performs the hash operation on the list of requested sub-authorization items and the first identification information in the first information to thereby obtain a first hash value.

The user equipment may encrypt the obtained first hash value by a pre-stored key, and transmit the first information, including the encrypted first hash value and the first identification information, to the authorization updating server.

Step 204, receiving second information transmitted from the authorization updating server.

The authorization updating server processes the first information from the user equipment and obtains the third list of sub-authorization items to be updated. The authorization updating server returns the second information including the third list of sub-authorization items responding to the first information after the first information is transmitted to the authorization updating server.

Step 205, performing resource updating on the sub-authorization items to be updated in the resource certificate according to the sub-authorization items in a third list of sub-authorization items in the second information.

For example, the user equipment may first decrypt a third hash value in the second information by the pre-stored key, and obtain the third hash value. The user equipment may then perform a hash operation on the third list of sub-authorization items in the second information to obtain a fourth hash value.

The user equipment then matches the decrypted third hash value with the fourth hash value. If the third hash value does not match the fourth hash value, i.e., the user equipment determines that the matching fails, the updating of the sub-authorization items also fails. If the third hash value is the same as the fourth hash value, the user equipment determines that the matching succeeds. Then, the user equipment performs resource updating on the sub-authorization items to be updated in the resource certificate according to the sub-authorization items in the third list of sub-authorization items in the second information.

According to some embodiments, the sub-authorization items may be updated by replacing the sub-authorization items to be updated or invalidated in the resource certificate with the sub-authorization items in the third list of sub-authorization items.

According to some embodiments, the key of the user equipment is synchronized with the key in the authorization updating server, and both hash operations use the same hash algorithm.

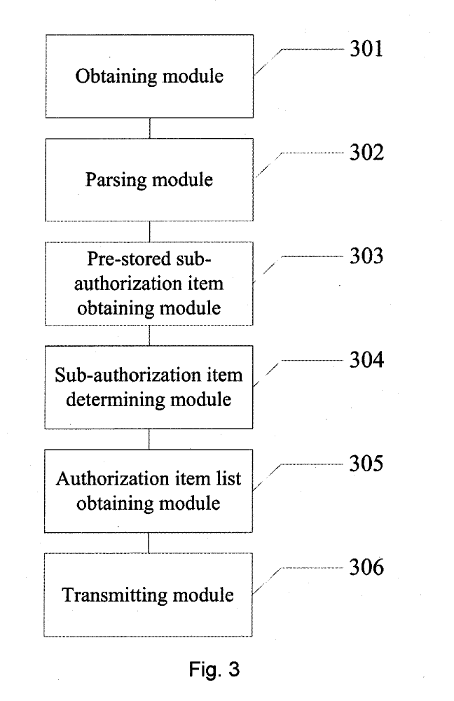

FIG. 3 illustrates a schematic structural diagram of an apparatus for updating an authorization according to some embodiments of the present disclosure. The apparatus may include an obtaining module 301 configured to obtain first information transmitted from a user equipment requesting for updating authorization items, a parsing module 302 configured to parse the obtained first information to obtain first identification information and a list of requested sub-authorization items in the first information, and a sub-authorization item obtaining module 303 configured to obtain a corresponding list of sub-authorization items according to the first identification information, a sub-authorization item determining module 304 configured to determine sub-authorization items to be updated of the user equipment according to the first information, an authorization item list obtaining module 305 configured to generate a third list of sub-authorization items corresponding to the sub-authorization items determined to be updated, a transmitting module 306 configured to transmit the third list of sub-authorization items to the user equipment.

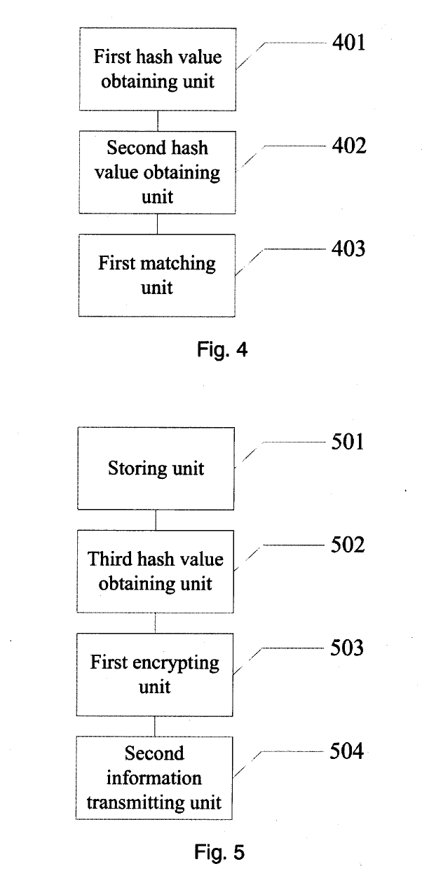

FIG. 4 illustrates a schematic diagram of a specific structure of the sub-authorization item determining module according to some embodiments of the present disclosure. The sub-authorization item determining module may include a first hash value obtaining unit 401 configured to decrypt a first hash value in the first information by a pre-stored key and to obtain the first hash value, a second hash value obtaining unit 402 configured to perform a hash operation on the obtained first identification information and the list of requested sub-authorization items to obtain a second hash value, and a first matching unit 403 configured to match the first hash value with the second hash value. If the matching fails, the sub-authorization item determining module indicates a failure of updating the requested sub-authorization items, and if the matching succeeds, the sub-authorization item determining module obtains the pre-stored sub-authorization items corresponding to the first user identification information and first certificate identification information according to the first user identification information and the first certificate identification information.

FIG. 5 illustrates a schematic diagram of a specific structure of the transmitting module according to some embodiments of the present disclosure. The transmitting module may include a storing unit 501 configured to store the third list of authorization items, a third hash value obtaining unit 502 configured to perform a hash operation on the third list of authorization items to obtain a third hash value corresponding to the third list of authorization items, a first encrypting unit 503 configured to encrypt the third hash value by the pre-stored key, and a second information transmitting unit 504 configured to transmit second information, including the third list of sub-authorization items and the third hash value, to the user equipment.

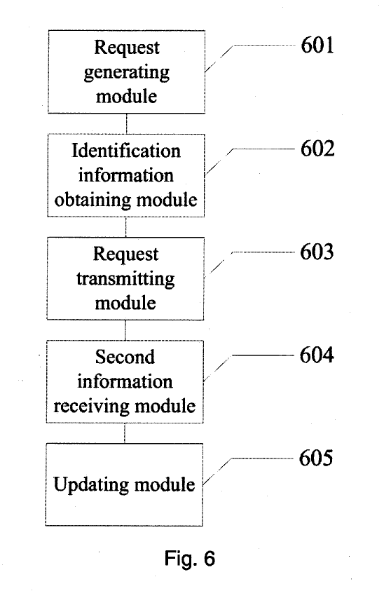

FIG. 6 illustrates a schematic structural diagram of an apparatus for updating sub-authorization items according to some embodiments of the present disclosure. The apparatus may include a request generating module 601 configured to check each sub-authorization item in a resource certificate for validity, to obtain sub-authorization items to be requested for updating according to a result of the check and to generate a list of requested sub-authorization items. The list of requested sub-authorization may include the requested sub-authorization items. The apparatus may further include an identification information obtaining module 602 configured to obtain first identification information in a user equipment. The first identification information may include first user identification information, first device information and first certificate identification information. The apparatus may further include a request transmitting module 603 configured to transmit first information, including the list of requested sub-authorization items and the first identification information, to an authorization updating server, a second information receiving module 604 configured to receive second information transmitted from the server, and an updating module 605 configured to performing resource certificate updating on the sub-authorization items to be updated in the resource certificate according to the sub-authorization items in a third list of sub-authorization items in the second information.

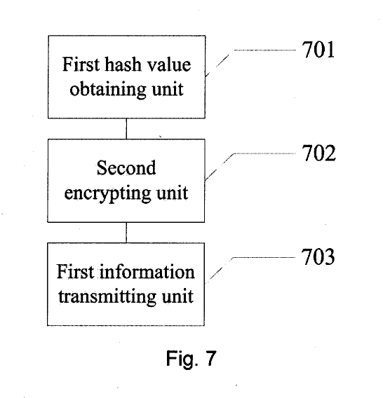

FIG. 7 illustrates a schematic diagram of a specific structure of the request transmitting module according to some embodiments of the present disclosure. The request transmitting module may include a first hash value obtaining unit 701 configured to perform a hash operation on the list of requested sub-authorization items and the first identification information in the first information to obtain a first hash value, a second encrypting unit 702 configured to encrypt the first hash value by a key, and a first information transmitting unit 703 configured to transmit the first information, including the first hash value, the list of requested sub-authorization items and the first identification information, to the authorization updating server.

The disclosure provides a method and apparatus for updating an authorization of using electronic information. According to some embodiments, an authorization updating server obtains first information transmitted from a user equipment requesting for updating authorization items, determines sub-authorization items to be updated according to the first information, generates a third list of sub-authorization items corresponding to the sub-authorization items determined to be updated and transmits the third list of sub-authorization items to the user equipment so that the user equipment performs authorization updating according to the sub-authorization items to be updated in the third list of sub-authorization items. Thus, digital content authorization can be updated efficiently by updating only the contents of sub-authorization items to thereby reduce work on the server side and avoid the problem of repeated authorization updating of a certificate.

It shall be understood by those skilled in the prior art that, the embodiments of the present disclosure may be provided as methods, systems or computer program products. Thus, the present disclosure may be in the form of hardware embodiments, software embodiments, or software and hardware combined embodiments. Furthermore, the present disclosure may be in the form of computer program products implemented on one or a plurality of computer-readable memory media (including but not limited to disc memory unit and optical memory unit, etc.) containing computer-readable program codes therein.

The embodiments are described with reference to the flowcharts and/or block diagrams of the methods, equipment (systems) and computer program products in accordance with the embodiments of the present disclosure. It shall be understood that each flow and/or block/module in the flowcharts and/or block/module diagrams, as well as the combination of flows and/or blocks/modules in the flowcharts and/or block/module diagrams may be implemented by computer program instructions. These computer program instructions may be offered to a universal computer, a dedicated computer, an embedded-type processor or the processing units of other programmable data processing equipment to generate a machine unit, thus a device for implementing the functions designated in one or a plurality of flows in the flowcharts and/or one or a plurality of blocks/module in the block/module diagrams is generated via instructions executed by computers, processors, or processing units of other programmable data processing equipment.

These computer program instructions may also be stored in a computer readable memory unit capable of enabling computers or other programmable data processing equipment to operate in a specific way, thus the manufactured products including an instruction device, such as a computer, are generated by the instructions stored in the computer readable memory unit, and the instruction device implements the functions designated in one or a plurality of flows in the flowcharts and/or one or a plurality of blocks/modules in the block/module diagrams.

These computer program instructions may also be loaded on computers or other programmable data processing equipment, thus a series of operation steps are executed on the computers or other programmable equipment to generate computer-implementable processing, so that the instructions executed on the computers or other programmable equipment provide the steps of implementing the functions designated in one or a plurality of flows in the flowcharts and/or one or a plurality of blocks/modules in the block/module diagrams.

Other embodiments of the disclosure will be apparent to those skilled in the art from consideration of the specification and practice of the invention disclosed herein. It is intended that the specification and examples be considered as exemplary only, with a true scope and spirit of the invention being indicated by the following claims.

1. A method for updating an authorization of electronic information, comprising:
receiving, by an authorization updating server, first information from a user equipment requesting for updating authorization items, wherein the first information includes first identification information and a first list of authorization items requested to be updated;
determining, by the authorization updating server, a second list of authorization items stored in the authorization updating server that correspond to the first identification information;
comparing, by the authorization updating server, the first list of authorization items and the second list of authorization items and determining a third list including authorization items that are listed in both the first list and the second list of authorization items; and
transmitting, by the authorization updating server, the third list of authorization items to the user equipment.

2. The method according to claim 1, wherein the first identification information includes user identification information and certificate identification information of an authorization certificate associated with the user.

3. The method according to claim 1, further comprising:
parsing the first information to obtain the first identification information and the first list of authorization items.

4. The method according to claim 1, wherein the first information further comprises an encrypted first hash value.

5. The method according to claim 4, further comprising:
decrypting the first hash value in the first information by a pre-stored key;
performing a hash operation on the first identification information and the first list of authorization items to obtain a second hash value; and
matching the first hash value with the second hash value, and if the matching fails, indicating a failure of updating the requested authorization items; if the matching succeeds, allowing the authorization updating server to determine the second list of authorization items.

6. The method according to claim 5, further comprising, before transmitting the third list:
performing a hash operation on the third list of authorization items to obtain a third hash value;
encrypting the third hash value by the pre-stored key; and
transmitting the third list of authorization items and the third hash value to the user equipment.

7. The method according to claim 5, wherein the hash operation uses a hash algorithm that is the same as a hash algorithm used to obtain the first hash value.

8. A method for updating authorization items, comprising:
checking, by a user equipment, each authorization item in a resource certificate for validity, and generating a first list of authorization items to request for updating according to a result of the checking;
obtaining first identification information, wherein the first identification information comprises user identification information and certificate identification information;
transmitting first information to an authorization updating server, wherein the first information includes the first list of authorization items and the first identification information;
receiving a third list of authorization items from the authorization updating server; and
updating authorization items in the resource certificate according to the authorization items in the third list.

9. The method according to claim 8, further comprising:
performing a hash operation on the first list of authorization items and the first identification information in the first information to obtain a first hash value; and
encrypting the first hash value by a key,
wherein transmitting the first information further includes transmitting the first hash value.

10. The method according to claim 8, further comprising, before updating authorization items in the resource certificate:
decrypting a third hash value from the authorization updating server by the key, and obtaining the third hash value;
performing a hash operation on the third list of authorization items, and obtaining a fourth hash value; and
matching the third hash value with the fourth hash value, and if the matching fails, indicating a failure of updating the authorization items; if the matching succeeds, allowing updating the authorization items in the resource certificate.

11. The method according to claim 10, wherein updating the authorization items in the resource certificate comprises:
replacing the authorization items to be updated in the resource certificate with the authorization items in the third list of authorization items.

12. An apparatus for updating authorization of use of electronic information, comprising:
an obtaining module configured to obtain first information from a user equipment requesting for updating authorization items, wherein the first information includes a first list of authorization items requested to be updated and first identification information;
an authorization item determining module configured to compare the first list of authorization items with a second list that includes authorization items stored in the apparatus and correspond to the first identification information, and determine authorization items that are in the first list and the second list as authorization items to be updated;
an authorization item list obtaining module configured to generate a third list of authorization items determined to be updated for the user equipment; and
a transmitting module configured to transmit the third list of authorization items determined to be updated for the user equipment to the user equipment.

13. The apparatus according to claim 12, further comprising:
a parsing module configured to parse the first information to obtain the first identification information and the first list of authorization items.

14. The apparatus according to claim 12, wherein the authorization item determining module comprises:
a first hash value obtaining unit configured to decrypt a first hash value in the first information by a pre-stored key and to obtain the first hash value;
a second hash value obtaining unit configured to perform a hash operation on the first identification information and the first list of authorization items to obtain a second hash value; and
a first matching unit configured to match the first hash value with the second hash value, and if the matching fails, to indicate a failure of updating the requested authorization items; if the matching succeeds, to allow the authorization item determining module to compare the first list of authorization items with the second list of authorization items, and determine authorization items that are in the first list and the second list as authorization items to be updated.

15. The apparatus according to claim 12, wherein the transmitting module comprises:
a third hash value obtaining unit configured to perform a hash operation on the first list of authorization items to obtain a third hash value corresponding to the first list of authorization items; and
a first encrypting unit configured to encrypt the third hash value by the pre-stored key,
wherein the transmitting module is further configured to transmit the third hash value to the user equipment.
